(19) United States
(12) Patent Application Publication
(10) Pub. No.: US 2024/0201495 A1
(43) Pub. Date: Jun. 20, 2024

(54) APPARATUS, SYSTEM, AND METHOD FOR INCREASING CONTRAST IN PANCAKE LENSES VIA ASYMMETRIC BEAM SPLITTERS

(71) Applicant: Meta Platforms Technologies, LLC, Menlo Park, CA (US)

(72) Inventors: Andrew John Ouderkirk, Kirkland, WA (US); Fenglin Peng, Redmond, WA (US); Ying Geng, Bellevue, WA (US)

(21) Appl. No.: 18/067,756

(22) Filed: Dec. 19, 2022

(51) Int. Cl. G02B 27/01; G02B 5/30; G02B 25/00

(52) U.S. Cl. CPC G02B 27/0172; G02B 5/3025; G02B 5/3083; G02B 25/001

(57) ABSTRACT

A head-mounted display comprising (1) an electronic display configured to emit light and (2) a pancake lens optically coupled to the electronic display, the pancake lens comprising a beam splitter configured to (A) transmit a spatial average fraction of the light and (B) reflect an additional spatial average fraction of the light that is less than the spatial average fraction of the light. Various other apparatuses, devices, systems, and methods are also disclosed.

### BRIEF DESCRIPTION OF DRAWINGS

The accompanying drawings illustrate a number of exemplary embodiments and are parts of the specification. Together with the following description, the drawings demonstrate and explain various principles of the instant disclosure.

FIG. 1 is an illustration of an exemplary head-mounted display that facilitates increasing contrast in a pancake lens via an asymmetric beam splitter according to one or more embodiments of this disclosure.

FIG. 2 is an illustration of an exemplary implementation in which the contrast of a pancake lens is increased via an asymmetric beam splitter according to one or more embodiments of this disclosure.

FIG. 3 is an illustration of an exemplary implementation in which a head-mounted display facilitates increasing contrast in a pancake lens via an asymmetric beam splitter according to one or more embodiments of this disclosure.

FIG. 4 is an illustration of an exemplary implementation in which the contrast of a pancake lens is increased via an asymmetric beam splitter according to one or more embodiments of this disclosure.

FIG. 5 is an illustration of an exemplary beam splitter whose transmissibility is asymmetric according to one or more embodiments of this disclosure.

FIG. 6 is a flowchart of an exemplary method for increasing contrast in pancake lenses via asymmetric beam splitters according to one or more embodiments of this disclosure.

FIG. 7 is an illustration of exemplary augmented-reality system that may be used in connection with embodiments of this disclosure.

FIG. 8 is an illustration of an exemplary virtual-reality system that may be used in connection with embodiments of this disclosure.

FIG. 9 is an illustration of exemplary haptic devices that may be used in connection with embodiments of this disclosure.

FIG. 10 is an illustration of an exemplary virtual-reality environment according to embodiments of this disclosure.

FIG. 11 is an illustration of an exemplary augmented-reality environment according to embodiments of this disclosure.

While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, combinations, equivalents, and alternatives falling within this disclosure.

### DETAILED DESCRIPTION

The present disclosure is generally directed to apparatuses, systems, and methods for increasing contrast in pancake lenses via asymmetric beam splitters. As will be explained in greater detail below, these apparatuses, systems, and methods may provide numerous features and benefits.

In some examples, pancake lenses may be used and/or applied to form images from light emitted by displays in compact headsets. In such examples, the pancake lenses may be arranged and/or configured to provide and/or deliver these images for presentation to or viewing by users of the compact headsets. Unfortunately, some pancake lenses may be susceptible to contrast reduction, which may degrade and/or impair the quality of the images as perceived by the users. For example, reduced contrast may result from and/or be caused by light that illuminates users' eyes and/or surrounding regions and then reenters the pancake lenses. This light may then be reflected back to the users' eyes, thereby reducing contrast and possibly even forming unwanted ghost images.

In some examples, users may be sensitive to image contrast ratios—with higher contrast ratios leading to better user experiences and/or viewability than lower contrast ratios. Accordingly, the user experiences and/or viewability may improve and/or advance as the contrast ratio of the headsets increases. For example, the number of ghosts present in images generated by these headsets may decrease as the contrast ratio increases.

One way to achieve this objective may involve applying asymmetric beam splitters to pancake lenses in compact headsets. For example, such beam splitters may transmit at least a 60% spatial average fraction of light. By transmitting at least a 60% spatial average fraction of light, such beam splitters may enable pancake lenses to mitigate contrast reduction and/or improve the overall experiences of users wearing the headsets.

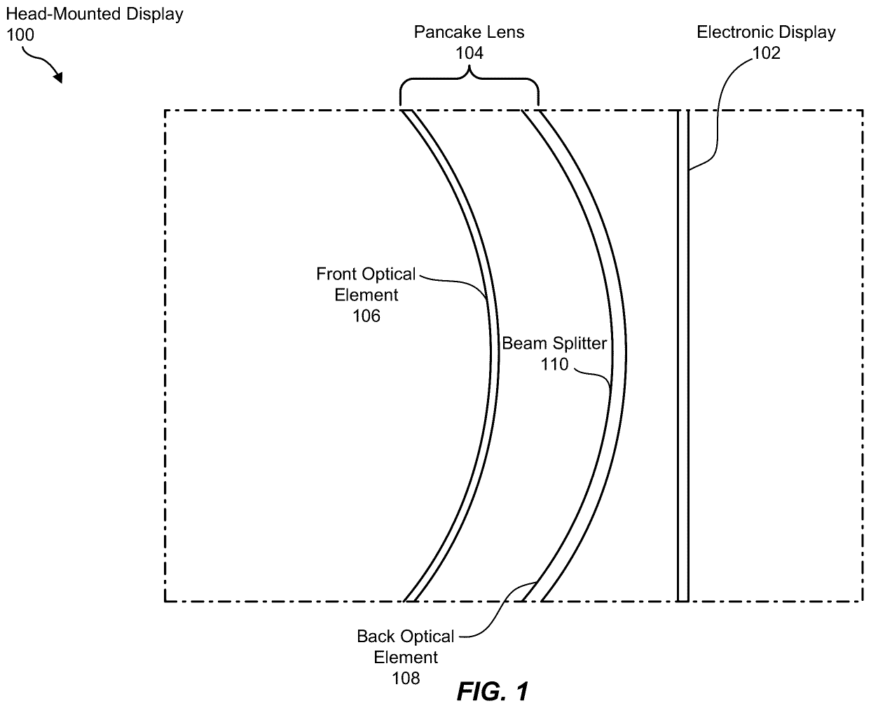

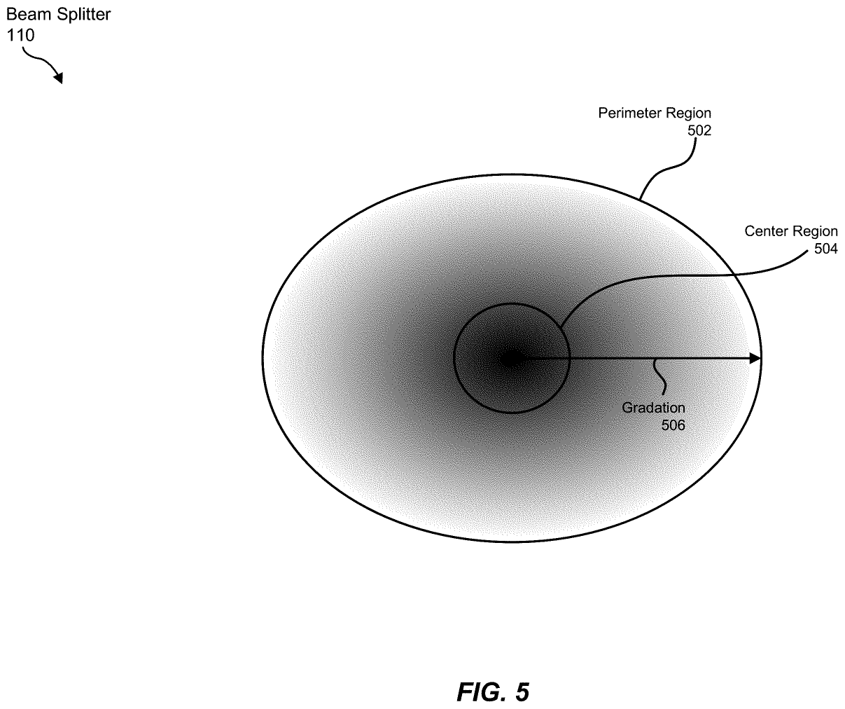

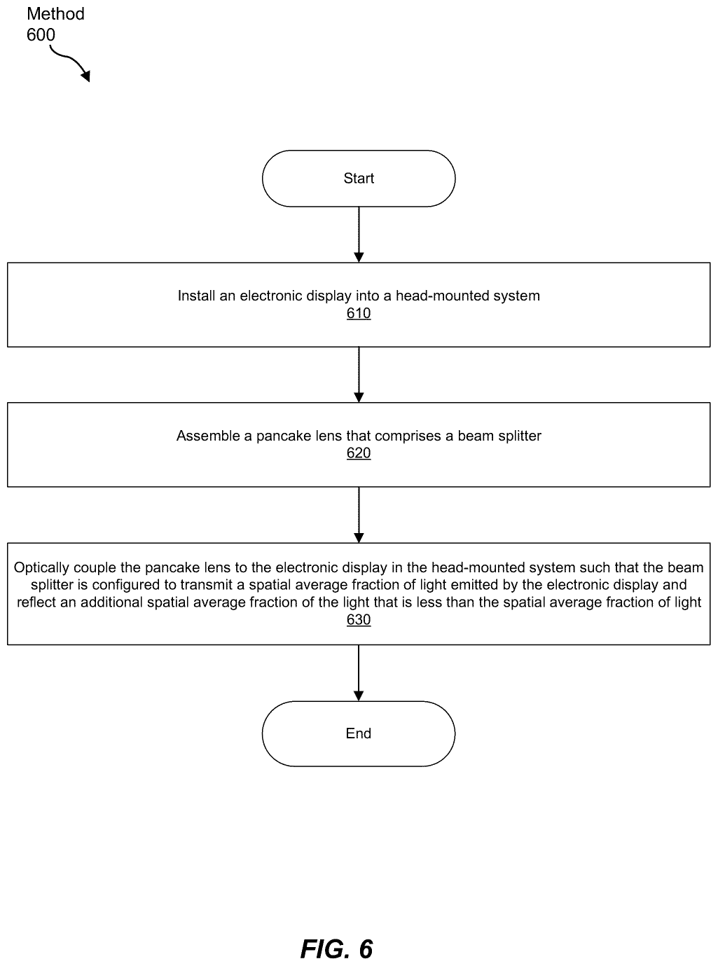

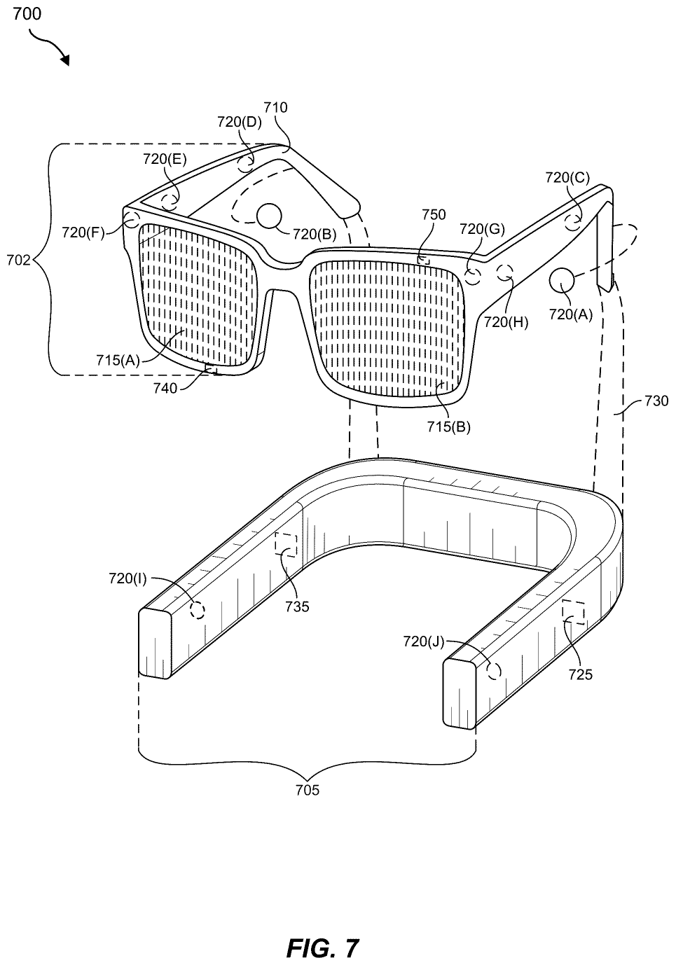

The following will provide, with reference to FIGS. 1-5, detailed descriptions of exemplary devices, systems, components, and corresponding implementations for increasing contrast in pancake lenses via asymmetric beam splitters. In addition, detailed descriptions of methods for increasing contrast in pancake lenses via asymmetric beam splitters will be provided in connection with FIG. 6. The discussion corresponding to FIGS. 7-11 will provide detailed descriptions of types of exemplary artificial-reality devices, wearables, and/or associated systems capable of increasing contrast in pancake lenses via asymmetric beam splitters.

FIG. 1 illustrates a portion of an exemplary head-mounted display 100 capable of increasing contrast in pancake lenses via asymmetric beam splitters. In some examples, head-mounted display 100 may include and/or represent an electronic display 102 and/or a pancake lens 104. In one example, electronic display 102 may emit light, and pancake lens 104 may be optically coupled to electronic display 102. In this example, pancake lens 104 may include and/or represent a front optical element 106 and/or a back optical element 108. In certain implementations, the optical coupling between electronic display 102 and pancake lens 104 may essentially align electronic display 102 and pancake lens 102 such that light rays and/or beams emitted by electronic display are aimed and/or directed into pancake lens 104. Accordingly, this optical coupling may form and/or establish an optical path from electronic display 102 to pancake lens 104.

In some examples, pancake lens 104 may include and/or represent a beam splitter 110 that transmits and/or conveys a spatial average fraction of the light emitted by electronic display 102. Additionally or alternatively, beam splitter 110 may reflect and/or reject an additional spatial average fraction of light that is less than the spatial average fraction of light transmitted by beam splitter 110. In one example, the spatial average fraction of light may include and/or represent an average of values measured over a certain region of beam splitter 110.

In some examples, beam splitter 110 may transmit and/or convey a spatial average of at least 60% of the light emitted by electronic display 102. In such examples, beam splitter 110 may reflect and/or reject no more than 40% of the light emitted by electronic display 102.

In another example, beam splitter 110 may transmit and/or convey a spatial average of at least 70% of the light emitted by electronic display 102. In this example, beam splitter 110 may reflect and/or reject no more than 30% of the light emitted by electronic display 102. In a further example, beam splitter 110 may transmit and/or convey a spatial average of at least 80% of the light emitted by electronic display 102. In this example, beam splitter 110 may reflect and/or reject no more than 20% of the light emitted by electronic display 102. In an additional example, beam splitter 110 may transmit and/or convey a spatial average of at least 85% of the light emitted by electronic display 102. In this example, beam splitter 110 may reflect and/or reject no more than 15% of the light emitted by electronic display 102.

In some examples, as illustrated in FIG. 7, beam splitter 110 may include and/or represent a center region 504 and a perimeter region 502. In such examples, beam splitter 110 may exhibit and/or be characterized by a gradation 506 of transmissibility from center region 504 to perimeter region 502. In one example, center region 504 may exhibit and/or be characterized by a transmissibility that is at least 5 percent higher than the transmissibility in perimeter region 502. Put another way, center region 504 may exhibit and/or be characterized by a reflectivity that is at least 5 percent lower than the reflectivity in perimeter region 502. In this example, perimeter region 502 may exhibit and/or be characterized by a transmissibility that is at least 5 percent lower than the transmissibility in center region 504. In other words, perimeter region 502 may exhibit and/or be characterized by a reflectivity that is at least 5 percent higher than the reflectivity in center region 504.

In another example, center region 504 may exhibit and/or be characterized by a transmissibility that is at least 10 percent higher than the transmissibility in perimeter region 502. Put another way, center region 504 may exhibit and/or be characterized by a reflectivity that is at least 10 percent lower than the reflectivity in perimeter region 502. In a further example, center region 504 may exhibit and/or be characterized by a transmissibility that is at least 30 percent higher than the transmissibility in perimeter region 502. In other words, center region 504 may exhibit and/or be characterized by a reflectivity that is at least 30 percent lower than the reflectivity in perimeter region 502.

In some examples, head-mounted display 100 may include and/or represent any type or form of device, component, and/or system that is dimensioned to be worn on a user's head and/or is equipped with a light source capable of projecting images into one or more of the user's eyes. In one example, head-mounted display 100 may facilitate, provide, and/or support an artificial reality (e.g., virtual reality, augmented reality, and/or mixed reality) environment for the user. Accordingly, head-mounted display 100 may include and/or represent an artificial-reality device, a virtual-reality device, an augmented-reality device, a mixed-reality device, a hybrid-reality device, portions of one or more of the same, combinations or variations of one or more of the same, and/or any other suitable head-mounted display.

In some examples, electronic display 102 may include and/or represent any type or form of display device, screen, and/or projector capable of presenting, delivering, and/or providing visual information, images, and/or light to the user. In one example, electronic display 102 may include and/or represent a light crystal display (LCD) display that spatially modulates light intensity. In this example, the LCD display may emit linearly polarized light capable of forming images destined for one or more of the user's eyes. Additional examples of electronic display 102 include, without limitation, a light emitting diode (LED) array, a microLED array, an organic LED (OLED) array, an active-matrix OLED (AMOLED) array, a scanned display (e.g., a 2-dimensional scanned laser), a projected LCD, a backlit LCD, a liquid crystal on silicon (LCoS) display, a ferroelectric LCOS (FLCoS) display, a flexible display, portions of one or more of the same, combinations or variations of one or more of the same, and/or any other suitable electronic display.

In some examples, pancake lens 104 may include and/or represent any type or form of folded optical assembly and/or system fitted with multiple optical elements (e.g., a front optical element 106 and/or a back optical element 108). In one example, pancake lens 104 may include and/or represent multiple lenses, a beam splitter, a reflective polarizer, and/or multiple quarter wave retarders. Additional examples of optical elements that may be incorporated in pancake lens 104 include, without limitation, coatings, films, half wave retarders, mirrors, absorbing polarizers, linear reflective polarizers, compound retarders, wave plates, portions of one or more of the same, combinations or variations of one or more of the same, and/or any other suitable optical elements.

In some examples, beam splitter 110 may transmit and/or convey a fraction of light with a desired wavelength range. In such examples, beam splitter 110 may reflect, reject, and/or absorb light outside the desired wavelength range. In one example, beam splitter 110 may include and/or represent a thin optical coating disposed on a transparent substrate and/or lens. Examples of beam splitter 110 include and/or represent an aluminum coating, a silver coating, a gold coating, a copper coating, one or more dielectric layers (e.g., magnesium fluoride, hafnium(IV) oxide, silicon dioxide, titanium dioxide, aluminum oxide, other inorganic materials, etc.), one or more polymer layers (e.g., polyvinylidene fluoride, polymethylmethacrylate, polystyrene, etc.), metal layers, portions of one or more of the same, combinations or variations of one or more of the same, and/or any other suitable beam splitter.

In certain implementations, the spatial reflectivity and/or transmissibility of beam splitter 110 may be optimized to achieve a display efficiency for desired images, contrast levels, and/or ghost rejection or avoidance. Additionally or alternatively, beam splitter 110 may be designed and/or configured to provide and/or impart a low scattering of the light emitted by electronic display 102.

In some examples, the average spatial transmission, reflection, and/or absorption may correspond to and/or represent the average values measured over a 5-millimeter diameter circle. In one example, the average values may exclude, omit, and/or avoid certain areas, including areas of beam splitter 110 (e.g., areas of high reflectivity outside the display's optical path), a reflective polarizer with relatively high transmission levels, eye-tracking areas, and/or any other suitably aberrational areas.

In some examples, the term “contrast” may refer to and/or represent a ratio of an image's bright region light intensity relative to the image's dark region light intensity. Additionally or alternatively, the contrast ratio may include and/or represent a ratio of the light intensity of a system's brightest shade relative to that of the system's darkest shade. In one example, contrast targets may vary across an image. For example, some images may exhibit higher contrast ratio targets toward the center and/or lower contrast ratio targets toward the perimeter.

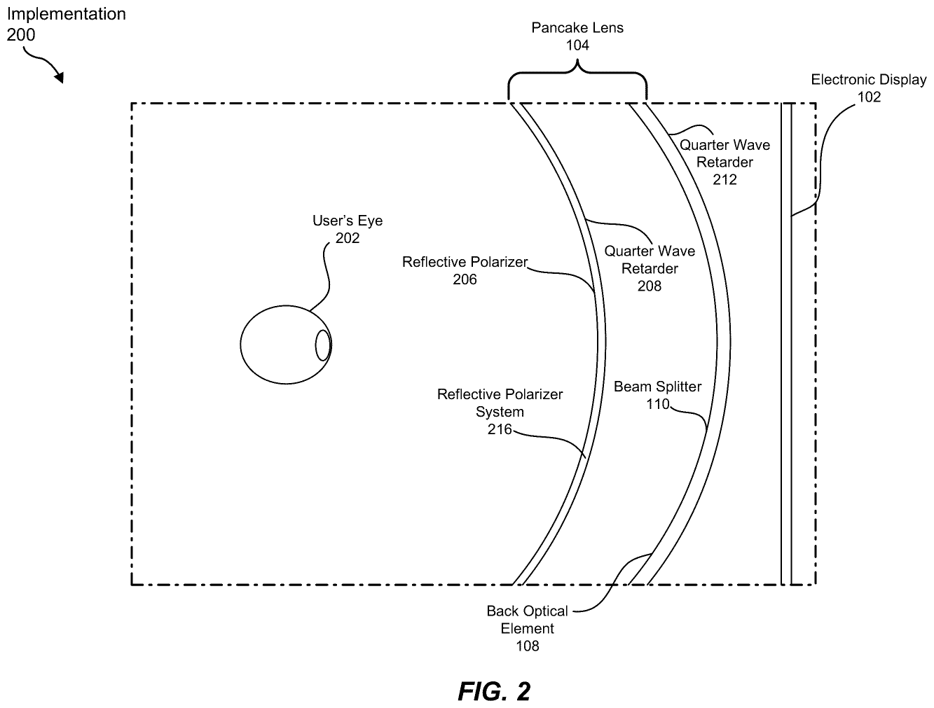

FIG. 2 illustrates a portion of an exemplary implementation 200 of head-mounted display 100 capable of increasing contrast in pancake lenses via asymmetric beam splitters. In some examples, implementation 200 may include and/or represent certain components and/or features that perform and/or provide functionalities that are similar and/or identical to those described above in connection with FIG. 1. As illustrated in FIG. 2, exemplary implementation 200 may involve and/or represent pancake lens 104 optically coupled to electronic display 102. In one example, pancake lens 104 may be configured and/or arranged to transmit and/or deliver a spatial average fraction of light emitted by electronic display 102 to a user's eye 202.

In one example, front optical element 106 of pancake lens 104 may include and/or represent a reflective polarizer system 216 disposed on and/or applied to a transparent substrate and/or lens. In this example, reflective polarizer system 216 may include and/or represent a reflective polarizer 206 and/or a quarter wave retarder 208. Examples of reflective polarizer 206 include, without limitation, a wire grid, a multilayered birefringent polymer reflective polarizer, a cholesteric reflective polarizer, portions of one or more of the same, combinations or variations of one or more of the same, and/or any other suitable reflective polarizer. Additionally or alternatively, back optical element 108 of pancake lens 104 may include and/or represent beam splitter 110 and/or a quarter wave retarder 212 disposed on and/or applied to a transparent substrate and/or lens.

In some examples, electronic display 102 may emit light that is linearly polarized. In such examples, electronic display 102 may provide, direct, and/or project the linearly polarized light to pancake lens 104. In one example, quarter wave retarder 212 of pancake lens 104 may convert and/or transform the linearly polarized light to circularly polarized light. In this example, the circularly polarized light may traverse and/or travel from back optical element 108 to reflective polarizer system 216.

In some examples, reflective polarizer system 216 may reflect and/or reject the circularly polarized light. For example, quarter wave retarder 208 of reflective polarizer system 216 may convert and/or transform the circularly polarized light back to linearly polarized light. In this example, reflective polarizer 206 of reflective polarizer system 216 may then reflect and/or reject the linearly polarized light.

In some examples, quarter wave retarder 212 may be positioned and/or placed between electronic display 102 and beam splitter 110. In such examples, quarter wave retarder 208 may be positioned and/or placed between beam splitter 110 and reflective polarizer 206.

In some examples, the arrangement and/or sequence of optical elements may vary depending on the specific needs and/or objectives of implementation 200. For example, although not necessarily illustrated in this way in FIG. 2, beam splitter 110 may be positioned and/or placed between electronic display 102 and quarter wave retarder 212. In such examples, reflective polarizer 206 may be positioned and/or placed between quarter wave retarder 212 and quarter wave retarder 208.

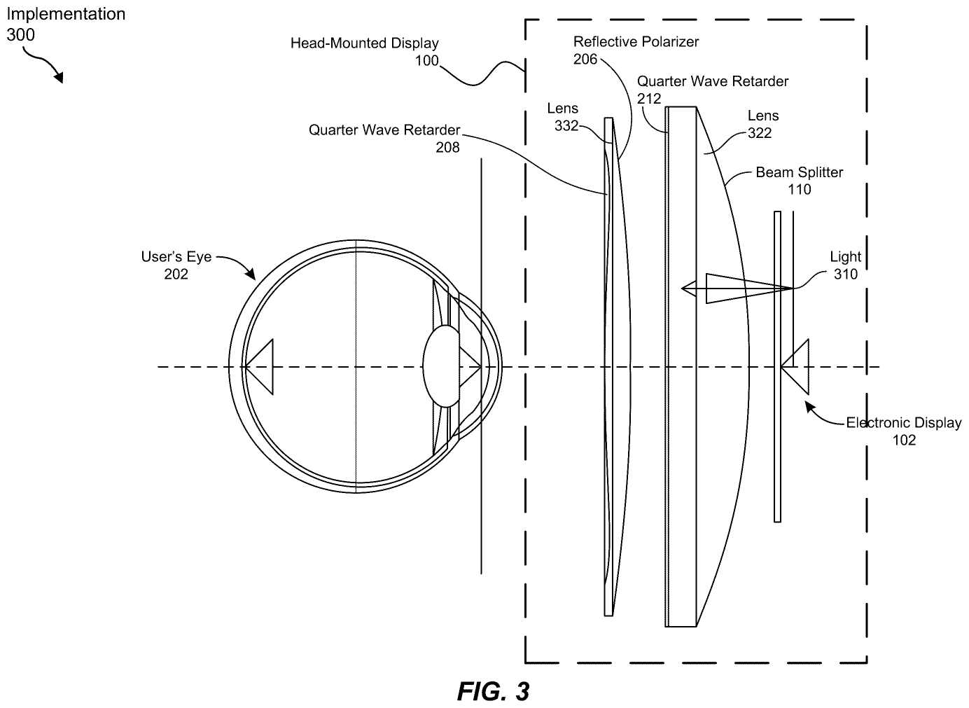

FIG. 3 illustrates a portion of an exemplary implementation 300 of head-mounted display 100 capable of increasing contrast in pancake lenses via asymmetric beam splitters. In some examples, implementation 300 may include and/or represent certain components and/or features that perform and/or provide functionalities that are similar and/or identical to those described above in connection with either FIG. 1 or FIG. 2. As illustrated in FIG. 3, head-mounted display 100 may include and/or represent a pancake lens that is comprised of lenses 322 and 332 and/or optically coupled to electronic display 102. In one example, quarter wave retarder 208 and/or reflective polarizer 206 may be disposed on and/or applied to lens 332, and quarter wave retarder 212 and/or beam splitter 110 may be disposed on and/or applied to lens 322.

In some examples, electronic display 102 may emit, direct, and/or project light 310 to the pancake lens. In one example, a beam splitter 110 may transmit and/or convey a spatial average fraction of light 310 emitted by electronic display 102. Additionally or alternatively, beam splitter 110 may reflect and/or reject an additional spatial average fraction of light 310 that is less than the spatial average fraction of light transmitted by beam splitter 110.

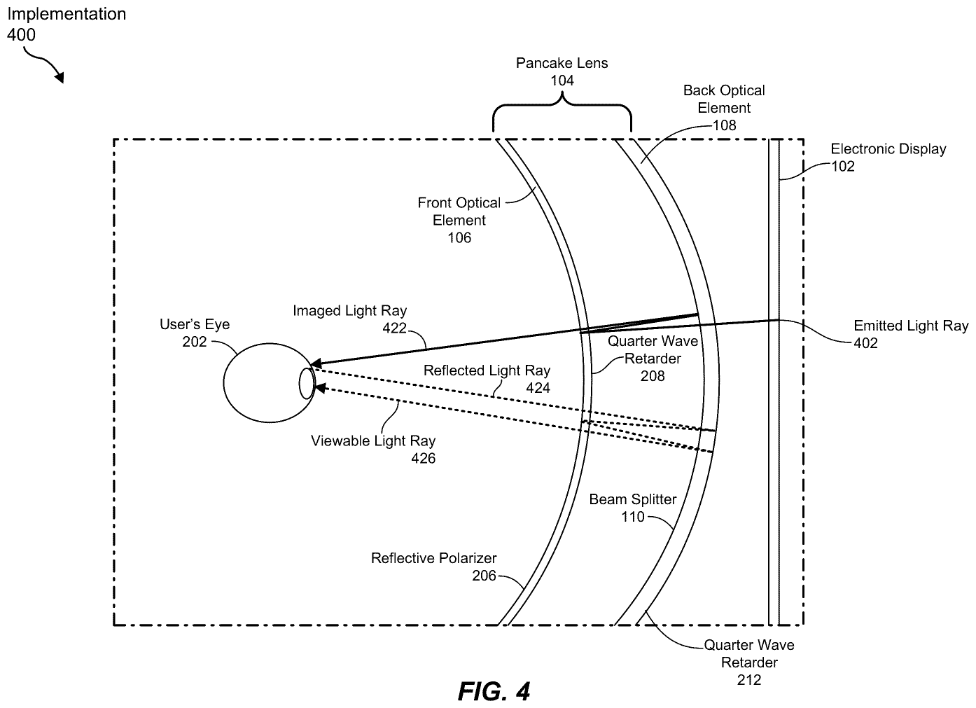

FIG. 4 illustrates a portion of an exemplary implementation 400 of head-mounted display 100 capable of increasing contrast in pancake lenses via asymmetric beam splitters. In some examples, implementation 400 may include and/or represent certain components and/or features that perform and/or provide functionalities that are similar and/or identical to those described above in connection with any of FIGS. 1-3. As illustrated in FIG. 4, exemplary implementation 200 may involve and/or represent electronic display 102 and pancake lens 104. In one example, pancake lens 104 may be optically coupled to electronic display 102, and electronic display 102 may emit a light ray 402 that is linearly polarized. In this example, emitted light ray 402 may traverse, pass, and/or travel through quarter wave retarder 212, which converts and/or transforms the linear polarity of emitted light ray 402 into a circular polarity.

In some examples, beam splitter 110 may exhibit and/or provide the desired spatial pattern of transmission and/or reflection (e.g., at least 60% transmission and/or at most 40% reflection). In one example, beam splitter 110 may also exhibit and/or provide low light absorption. In this example, emitted light ray 402 may traverse, pass, and/or travel from quarter wave retarder 212 to beam splitter 110, which splits and/or deconstructs emitted light ray 402 in accordance with the spatial pattern of transmission and/or reflection.

In some examples, after passing through beam splitter 110, emitted light ray 402 may traverse, pass, and/or travel to quarter wave retarder 208, which converts and/or transforms the circular polarity of emitted light ray 402 back into a linear polarity. In one example, reflective polarizer 206 may be oriented and/or configured to reflect a portion of emitted light ray 402 back through quarter wave retarder 208, which converts and/or transforms the linear polarity of emitted light ray 402 into a right-handed circular polarity. In this example, that portion of emitted light ray 402 may then traverse, pass, and/or travel back to beam splitter 110, which converts or transforms the right-handed circular polarity of emitted light ray 402 into a left-handed circular polarity and reflects that portion of emitted light ray 402 back toward quarter wave retarder 208.

In some examples, that portion of emitted light ray 402 may traverse, pass, and/or travel from beam splitter 110 back to quarter wave retarder 208, which converts and/or transforms the left-handed circular polarity of that portion of emitted light ray 402 back to a linear polarity. In one example, that portion of emitted light ray 402 may traverse, pass, and/or travel from quarter wave retarder 208 to reflective polarizer 206. In this example, reflective polarizer 206 may be oriented and/or configured to transmit linearly polarized light. As a result, that portion of emitted light ray 402 may traverse, pass, and/or travel through reflective polarizer 206 to user's eye 202 as an imaged light ray 422. Accordingly, the portion of emitted light ray 402 that passes through reflective polarizer 206 to user's eye 202 may constitute and/or represent imaged light ray 422.

In some examples, imaged light ray 422 may illuminate user's eye 202. In one example, a portion of imaged light ray 422 may be reflected back from user's eye toward pancake lens 104 as a reflected light ray 424. In this example, reflected light ray 424 may traverse, pass, and/or travel through front optical element 106 of pancake lens 104 to back optical element 108. At back optical element 108, reflected light ray 424 may bounce and/or be reflected back to front optical element 106 and then back again to back optical element 108. After reaching back optical element 108 again, a portion of reflected light ray 424 may be reflected and/or return through front optical element 106 to user's eye 202 as a viewable light ray 426.

In some examples, a lens and/or headset manufacturer may design head-mounted display 100 and/or pancake lens 104 by taking account of and/or considering various factors. In one example, the lens and/or headset manufacturer may design and/or optimize the display and/or pancake optics for a primary image. In this example, the lens and/or headset manufacturer may generate prototype images for consideration and/or analysis in performing contrast optimization.

In some examples, the lens and/or headset manufacturer may optimize the spatial reflectivity, transmission, and/or absorption profiles of beam splitter 110. To do so, the lens and/or headset manufacturer may account for and/or balance the image contrast ratio, ghosts, and/or image brightness. In one example, upon completion of these optimizations, the lens and/or headset manufacturer may make, produce, and/or obtain an optimized version of beam splitter 110 and then apply the same to back optical element 108. In this example, the lens and/or headset manufacturer may assemble beam splitter 110 and/or back optical element 108 into head-mounted display 100 and/or pancake lens 104. The resulting head-mounted display 100 and/or pancake lens 104 may exhibit and/or provide increased contrast relative to head-mounted displays and/or pancake lenses that exclude and/or omit such beam splitters.

In some examples, the various devices and/or systems described in connection with FIGS. 1-5 may include and/or represent one or more additional optical elements, components, and/or features that are not necessarily illustrated and/or labeled in FIGS. 1-5. For example, head-mounted display 100 may also include and/or represent additional lenses, beam splitters, reflective polarizers, quarter wave retarders, coatings, films, half wave retarders, mirrors, absorbing polarizers, linear reflective polarizers, compound retarders, wave plates, analog and/or digital circuitry, onboard logic, transistors, resistors, capacitors, diodes, inductors, switches, registers, flipflops, connections, traces, buses, semiconductor (e.g., silicon) devices and/or structures, processing devices, storage devices, circuit boards, packages, substrates, housings, portions of one or more of the same, combinations or variations of one or more of the same, and/or any other suitable optical elements or components.

In some examples, the phrase “to couple” and/or the term “coupling”, as used herein, may refer to a direct connection and/or an indirect connection. For example, a direct coupling between two components may constitute and/or represent a coupling in which those two components are directly connected to each other by a single node and/or path that provides electrical or optical continuity from one of those two components to the other. In other words, the direct coupling may exclude and/or omit any additional components between those two components.

Additionally or alternatively, an indirect coupling between two components may constitute and/or represent a coupling in which those two components are indirectly connected to each other by multiple nodes and/or paths that fail to provide electrical and/or optical continuity from one of those two components to the other. In other words, the indirect coupling may include and/or incorporate at least one additional component between those two components.

FIG. 6 is a flow diagram of an exemplary method 600 for increasing contrast in pancake lenses via asymmetric beam splitters. In one example, the steps shown in FIG. 6 may be performed during the manufacture and/or assembly of a wearable optical system, such as a head-mounted display. Additionally or alternatively, the steps shown in FIG. 6 may incorporate and/or involve various sub-steps and/or variations consistent with one or more of the descriptions provided above in connection with FIGS. 1-5.

As illustrated in FIG. 6, method 600 may include and/or involve the step of installing an electronic display into a head-mounted system (610). Step 610 may be performed in a variety of ways, including any of those described above in connection with FIGS. 1-5. For example, a wearable equipment manufacturer or subcontractor may install an electronic display into a head-mounted system.

In some examples, method 600 may also include and/or involve the step of assembling a pancake lens that comprises a beam splitter (620). Step 620 may be performed in a variety of ways, including any of those described above in connection with FIGS. 1-5. For example, the wearable equipment manufacturer or subcontractor may assemble a pancake lens that comprises a beam splitter.

In some examples, method 600 may also include and/or involve the step of optically coupling the pancake lens to the electronic display in the head-mounted system such that the beam splitter is configured to transmit a spatial average fraction of light emitted by the electronic display and reflect an additional spatial average fraction of the light that is less than the spatial average fraction of the light (630). Step 630 may be performed in a variety of ways, including any of those described above in connection with FIGS. 1-6. For example, the wearable equipment manufacturer or subcontractor may optically couple the pancake lens to the electronic display in the head-mounted system such that the beam splitter is configured to transmit a spatial average fraction of light emitted by the electronic display and reflect an additional spatial average fraction of the light that is less than the spatial average fraction of the light.

### Example Embodiments

Example 1: A head-mounted display comprising (1) an electronic display configured to emit light and (2) a pancake lens optically coupled to the electronic display, the pancake lens comprising a beam splitter configured to (A) transmit a spatial average fraction of the light and (B) reflect an additional spatial average fraction of the light that is less than the spatial average fraction of the light.

Example 2: The head-mounted display of Example 1, wherein the spatial average fraction of the light is at least 60 percent of the light.

Example 3: The head-mounted display of Example 1 or 2, wherein the beam splitter comprises a center region and a perimeter region, and the beam splitter exhibits a gradation of transmissibility from the center region to the perimeter region.

Example 4: The head-mounted display of any of Examples 1-3, wherein the gradation of transmissibility comprises transmissibility in the center region that is at least 5 percent higher than transmissibility in the perimeter region.

Example 5: The head-mounted display of any of Examples 1-4, wherein the light emitted by the display panel is linearly polarized, and the pancake lens comprises (1) a quarter wave retarder that converts the linearly polarized light to circularly polarized light and (2) a reflective polarizer system configured to reflect the circularly polarized light.

Example 6: The head-mounted display of any of Examples 1-5, wherein the reflective polarizer system comprises (1) an additional quarter wave retarder that converts the circularly polarized light to linearly polarized light and (2) a reflective polarizer that reflects the linearly polarized light.

Example 7: The head-mounted display of any of Examples 1-6, wherein the reflective polarizer comprises a multilayered birefringent polymer reflective polarizer and/or a wire grid.

Example 8: The head-mounted display of any of Examples 1-7, wherein the beam splitter is positioned between the electronic display and the quarter wave retarder, and the reflective polarizer is positioned between the quarter wave retarder and the additional quarter wave retarder.

Example 9: The head-mounted display of any of Examples 1-8, wherein the quarter wave retarder is positioned between the electronic display and the beam splitter, and the additional quarter wave retarder is positioned between the beam splitter and the reflective polarizer.

Example 10: The head-mounted display of any of Examples 1-9, wherein the beam splitter comprises a thin optical coating disposed on a lens.

Example 11: The head-mounted display of any of Examples 1-10, wherein the thin optical coating comprises an aluminum coating, a silver coating, a gold coating, and/or a copper coating.

Example 12: The head-mounted display of any of Examples 1-11, wherein the thin optical coating comprises at least one dielectric layer.

Example 13: The head-mounted display of any of Examples 1-12, wherein the thin optical coating comprises one or more layers of metal and dielectric material.

Example 14: The head-mounted display of any of Examples 1-13, wherein the spatial average fraction of the light comprises an average of values measured over a certain region of the beam splitter.

Example 15: An artificial-reality system comprising (1) an electronic display, (2) at least one processing device communicatively coupled to the electronic display and configured to direct the electronic display to emit light, and (3) a pancake lens optically coupled to the electronic display, the pancake lens comprising a beam splitter configured to (A) transmit a spatial average fraction of the light and (B) reflect an additional spatial average fraction of the light that is less than the spatial average fraction of the light.

Example 16: The artificial-reality system of claim 15, wherein the spatial average fraction of the light is at least 60 percent of the light.

Example 17: The artificial-reality system of either claim 15 or claim 16, wherein the beam splitter comprises a center region and a perimeter region, and the beam splitter exhibits a gradation of transmissibility from the center region to the perimeter region.

Example 18: The artificial-reality system of any of claims 15-17, wherein the gradation of transmissibility comprises transmissibility in the center region that is at least 5 percent higher than transmissibility in the perimeter region.

Example 19: The artificial-reality system of any of claims 15-18, wherein (1) the light emitted by the display panel is linearly polarized and (2) the pancake lens comprises (A) a quarter wave retarder that converts the linearly polarized light to circularly polarized light and (B) a reflective polarizer system configured to reflect the circularly polarized light.

Example 20: A method comprising (1) installing an electronic display into a head-mounted system, (2) assembling a pancake lens that comprises a beam splitter, and (3) optically coupling the pancake lens to the electronic display in the head-mounted system such that the beam splitter is configured to (A) transmit a spatial average fraction of light emitted by the electronic display and (B) reflect an additional spatial average fraction of the light that is less than the spatial average fraction of the light.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

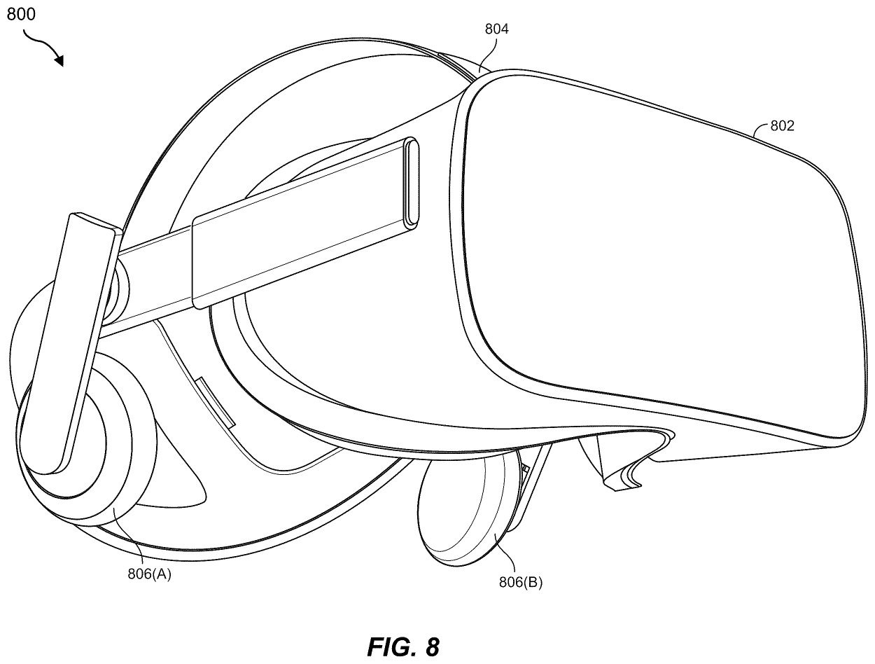

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 700 in FIG. 7) or that visually immerses a user in an artificial reality (such as, e.g., virtual-reality system 800 in FIG. 8). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 7, augmented-reality system 700 may include an eyewear device 702 with a frame 710 configured to hold a left display device 715(A) and a right display device 715(B) in front of a user's eyes. Display devices 715(A) and 715(B) may act together or independently to present an image or series of images to a user. While augmented-reality system 700 includes two displays, embodiments of this disclosure may be implemented in augmented-reality systems with a single NED or more than two NEDs.

In some embodiments, augmented-reality system 700 may include one or more sensors, such as sensor 740. Sensor 740 may generate measurement signals in response to motion of augmented-reality system 700 and may be located on substantially any portion of frame 710. Sensor 740 may represent one or more of a variety of different sensing mechanisms, such as a position sensor, an inertial measurement unit (IMU), a depth camera assembly, a structured light emitter and/or detector, or any combination thereof. In some embodiments, augmented-reality system 700 may or may not include sensor 740 or may include more than one sensor. In embodiments in which sensor 740 includes an IMU, the IMU may generate calibration data based on measurement signals from sensor 740. Examples of sensor 740 may include, without limitation, accelerometers, gyroscopes, magnetometers, other suitable types of sensors that detect motion, sensors used for error correction of the IMU, or some combination thereof.

In some examples, augmented-reality system 700 may also include a microphone array with a plurality of acoustic transducers 720(A)-720(J), referred to collectively as acoustic transducers 720. Acoustic transducers 720 may represent transducers that detect air pressure variations induced by sound waves. Each acoustic transducer 720 may be configured to detect sound and convert the detected sound into an electronic format (e.g., an analog or digital format). The microphone array in FIG. 7 may include, for example, ten acoustic transducers: 720(A) and 720(B), which may be designed to be placed inside a corresponding ear of the user, acoustic transducers 720(C), 720(D), 720(E), 720(F), 720(G), and 720(H), which may be positioned at various locations on frame 710, and/or acoustic transducers 720(I) and 720(J), which may be positioned on a corresponding neckband 705.

In some embodiments, one or more of acoustic transducers 720(A)-(J) may be used as output transducers (e.g., speakers). For example, acoustic transducers 720(A) and/or 720(B) may be earbuds or any other suitable type of headphone or speaker.

The configuration of acoustic transducers 720 of the microphone array may vary. While augmented-reality system 700 is shown in FIG. 7 as having ten acoustic transducers 720, the number of acoustic transducers 720 may be greater or less than ten. In some embodiments, using higher numbers of acoustic transducers 720 may increase the amount of audio information collected and/or the sensitivity and accuracy of the audio information. In contrast, using a lower number of acoustic transducers 720 may decrease the computing power required by an associated controller 750 to process the collected audio information. In addition, the position of each acoustic transducer 720 of the microphone array may vary. For example, the position of an acoustic transducer 720 may include a defined position on the user, a defined coordinate on frame 710, an orientation associated with each acoustic transducer 720, or some combination thereof.

Acoustic transducers 720(A) and 720(B) may be positioned on different parts of the user's ear, such as behind the pinna, behind the tragus, and/or within the auricle or fossa. Or, there may be additional acoustic transducers 720 on or surrounding the ear in addition to acoustic transducers 720 inside the ear canal. Having an acoustic transducer 720 positioned next to an ear canal of a user may enable the microphone array to collect information on how sounds arrive at the ear canal. By positioning at least two of acoustic transducers 720 on either side of a user's head (e.g., as binaural microphones), augmented-reality system 700 may simulate binaural hearing and capture a 3D stereo sound field around about a user's head. In some embodiments, acoustic transducers 720(A) and 720(B) may be connected to augmented-reality system 700 via a wired connection 730, and in other embodiments acoustic transducers 720(A) and 720(B) may be connected to augmented-reality system 700 via a wireless connection (e.g., a BLUETOOTH connection). In still other embodiments, acoustic transducers 720(A) and 720(B) may not be used at all in conjunction with augmented-reality system 700.

Acoustic transducers 720 on frame 710 may be positioned in a variety of different ways, including along the length of the temples, across the bridge, above or below display devices 715(A) and 715(B), or some combination thereof. Acoustic transducers 720 may also be oriented such that the microphone array is able to detect sounds in a wide range of directions surrounding the user wearing the augmented-reality system 700. In some embodiments, an optimization process may be performed during manufacturing of augmented-reality system 700 to determine relative positioning of each acoustic transducer 720 in the microphone array.

In some examples, augmented-reality system 700 may include or be connected to an external device (e.g., a paired device), such as neckband 705. Neckband 705 generally represents any type or form of paired device. Thus, the following discussion of neckband 705 may also apply to various other paired devices, such as charging cases, smart watches, smart phones, wrist bands, other wearable devices, hand-held controllers, tablet computers, laptop computers, other external compute devices, etc.

As shown, neckband 705 may be coupled to eyewear device 702 via one or more connectors. The connectors may be wired or wireless and may include electrical and/or non-electrical (e.g., structural) components. In some cases, eyewear device 702 and neckband 705 may operate independently without any wired or wireless connection between them. While FIG. 7 illustrates the components of eyewear device 702 and neckband 705 in example locations on eyewear device 702 and neckband 705, the components may be located elsewhere and/or distributed differently on eyewear device 702 and/or neckband 705. In some embodiments, the components of eyewear device 702 and neckband 705 may be located on one or more additional peripheral devices paired with eyewear device 702, neckband 705, or some combination thereof.

Pairing external devices, such as neckband 705, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 700 may be provided by a paired device or shared between a paired device and an eyewear device, thus reducing the weight, heat profile, and form factor of the eyewear device overall while still retaining desired functionality. For example, neckband 705 may allow components that would otherwise be included on an eyewear device to be included in neckband 705 since users may tolerate a heavier weight load on their shoulders than they would tolerate on their heads. Neckband 705 may also have a larger surface area over which to diffuse and disperse heat to the ambient environment. Thus, neckband 705 may allow for greater battery and computation capacity than might otherwise have been possible on a stand-alone eyewear device. Since weight carried in neckband 705 may be less invasive to a user than weight carried in eyewear device 702, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 705 may be communicatively coupled with eyewear device 702 and/or to other devices. These other devices may provide certain functions (e.g., tracking, localizing, depth mapping, processing, storage, etc.) to augmented-reality system 700. In the embodiment of FIG. 7, neckband 705 may include two acoustic transducers (e.g., 720(l) and 720(J)) that are part of the microphone array (or potentially form their own microphone subarray). Neckband 705 may also include a controller 725 and a power source 735.

Acoustic transducers 720(I) and 720(J) of neckband 705 may be configured to detect sound and convert the detected sound into an electronic format (analog or digital). In the embodiment of FIG. 7, acoustic transducers 720(l) and 720(J) may be positioned on neckband 705, thereby increasing the distance between the neckband acoustic transducers 720(l) and 720(J) and other acoustic transducers 720 positioned on eyewear device 702. In some cases, increasing the distance between acoustic transducers 720 of the microphone array may improve the accuracy of beamforming performed via the microphone array. For example, if a sound is detected by acoustic transducers 720(C) and 720(D) and the distance between acoustic transducers 720(C) and 720(D) is greater than, e.g., the distance between acoustic transducers 720(D) and 720(E), the determined source location of the detected sound may be more accurate than if the sound had been detected by acoustic transducers 720(D) and 720(E).

Controller 725 of neckband 705 may process information generated by the sensors on neckband 705 and/or augmented-reality system 700. For example, controller 725 may process information from the microphone array that describes sounds detected by the microphone array. For each detected sound, controller 725 may perform a direction-of-arrival (DOA) estimation to estimate a direction from which the detected sound arrived at the microphone array. As the microphone array detects sounds, controller 725 may populate an audio data set with the information. In embodiments in which augmented-reality system 700 includes an inertial measurement unit, controller 725 may compute all inertial and spatial calculations from the IMU located on eyewear device 702. A connector may convey information between augmented-reality system 700 and neckband 705 and between augmented-reality system 700 and controller 725. The information may be in the form of optical data, electrical data, wireless data, or any other transmittable data form. Moving the processing of information generated by augmented-reality system 700 to neckband 705 may reduce weight and heat in eyewear device 702, making it more comfortable to the user.

Power source 735 in neckband 705 may provide power to eyewear device 702 and/or to neckband 705. Power source 735 may include, without limitation, lithium ion batteries, lithium-polymer batteries, primary lithium batteries, alkaline batteries, or any other form of power storage. In some cases, power source 735 may be a wired power source. Including power source 735 on neckband 705 instead of on eyewear device 702 may help better distribute the weight and heat generated by power source 735.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 800 in FIG. 8, that mostly or completely covers a user's field of view. Virtual-reality system 800 may include a front rigid body 802 and a band 804 shaped to fit around a user's head. Virtual-reality system 800 may also include output audio transducers 806(A) and 806(B). Furthermore, while not shown in FIG. 8, front rigid body 802 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 700 and/or virtual-reality system 800 may include one or more liquid crystal displays (LCDs), light emitting diode (LED) displays, microLED displays, organic LED (OLED) displays, digital light project (DLP) micro-displays, liquid crystal on silicon (LCOS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 700 and/or virtual-reality system 800 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 700 and/or virtual-reality system 800 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

As noted, artificial-reality systems 700 and 800 may be used with a variety of other types of devices to provide a more compelling artificial-reality experience. These devices may be haptic interfaces with transducers that provide haptic feedback and/or that collect haptic information about a user's interaction with an environment. The artificial-reality systems disclosed herein may include various types of haptic interfaces that detect or convey various types of haptic information, including tactile feedback (e.g., feedback that a user detects via nerves in the skin, which may also be referred to as cutaneous feedback) and/or kinesthetic feedback (e.g., feedback that a user detects via receptors located in muscles, joints, and/or tendons).

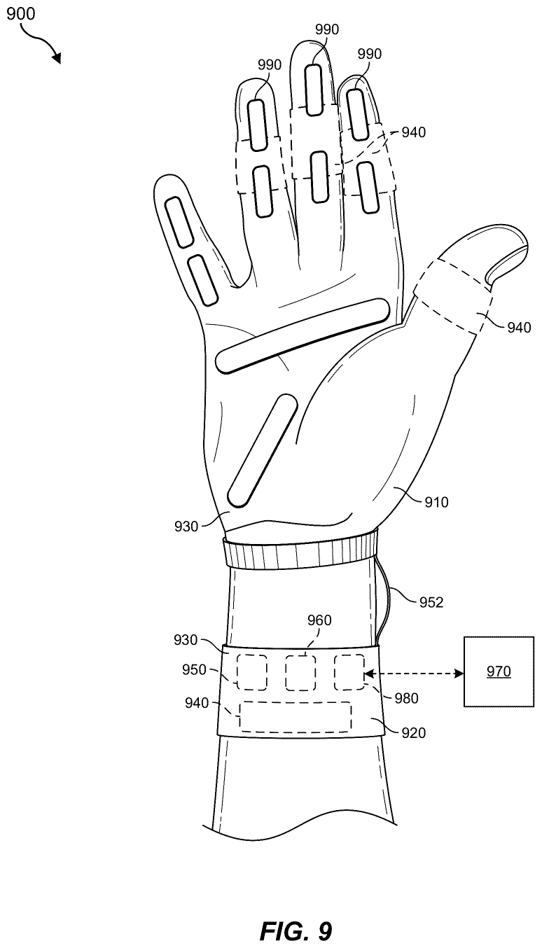

Haptic feedback may be provided by interfaces positioned within a user's environment (e.g., chairs, tables, floors, etc.) and/or interfaces on articles that may be worn or carried by a user (e.g., gloves, wristbands, etc.). As an example, FIG. 9 illustrates a vibrotactile system 900 in the form of a wearable glove (haptic device 910) and wristband (haptic device 920). Haptic device 910 and haptic device 920 are shown as examples of wearable devices that include a flexible, wearable textile material 930 that is shaped and configured for positioning against a user's hand and wrist, respectively. This disclosure also includes vibrotactile systems that may be shaped and configured for positioning against other human body parts, such as a finger, an arm, a head, a torso, a foot, or a leg. By way of example and not limitation, vibrotactile systems according to various embodiments of the present disclosure may also be in the form of a glove, a headband, an armband, a sleeve, a head covering, a sock, a shirt, or pants, among other possibilities. In some examples, the term “textile” may include any flexible, wearable material, including woven fabric, non-woven fabric, leather, cloth, a flexible polymer material, composite materials, etc.

One or more vibrotactile devices 940 may be positioned at least partially within one or more corresponding pockets formed in textile material 930 of vibrotactile system 900. Vibrotactile devices 940 may be positioned in locations to provide a vibrating sensation (e.g., haptic feedback) to a user of vibrotactile system 900. For example, vibrotactile devices 940 may be positioned against the user's finger(s), thumb, or wrist, as shown in FIG. 9. Vibrotactile devices 940 may, in some examples, be sufficiently flexible to conform to or bend with the user's corresponding body part(s).

A power source 950 (e.g., a battery) for applying a voltage to the vibrotactile devices 940 for activation thereof may be electrically coupled to vibrotactile devices 940, such as via conductive wiring 952. In some examples, each of vibrotactile devices 940 may be independently electrically coupled to power source 950 for individual activation. In some embodiments, a processor 960 may be operatively coupled to power source 950 and configured (e.g., programmed) to control activation of vibrotactile devices 940.

Vibrotactile system 900 may be implemented in a variety of ways. In some examples, vibrotactile system 900 may be a standalone system with integral subsystems and components for operation independent of other devices and systems. As another example, vibrotactile system 900 may be configured for interaction with another device or system 970. For example, vibrotactile system 900 may, in some examples, include a communications interface 980 for receiving and/or sending signals to the other device or system 970. The other device or system 970 may be a mobile device, a gaming console, an artificial-reality (e.g., virtual-reality, augmented-reality, mixed-reality) device, a personal computer, a tablet computer, a network device (e.g., a modem, a router, etc.), a handheld controller, etc. Communications interface 980 may enable communications between vibrotactile system 900 and the other device or system 970 via a wireless (e.g., Wi-Fi, BLUETOOTH, cellular, radio, etc.) link or a wired link. If present, communications interface 980 may be in communication with processor 960, such as to provide a signal to processor 960 to activate or deactivate one or more of the vibrotactile devices 940.

Vibrotactile system 900 may optionally include other subsystems and components, such as touch-sensitive pads 990, pressure sensors, motion sensors, position sensors, lighting elements, and/or user interface elements (e.g., an on/off button, a vibration control element, etc.). During use, vibrotactile devices 940 may be configured to be activated for a variety of different reasons, such as in response to the user's interaction with user interface elements, a signal from the motion or position sensors, a signal from the touch-sensitive pads 990, a signal from the pressure sensors, a signal from the other device or system 970, etc.

Although 950, processor 960, and communications interface 980 are illustrated in FIG. 9 as being positioned in haptic device 920, the present disclosure is not so limited. For example, one or more of power source 950, processor 960, or communications interface 980 may be positioned within haptic device 910 or within another wearable textile.

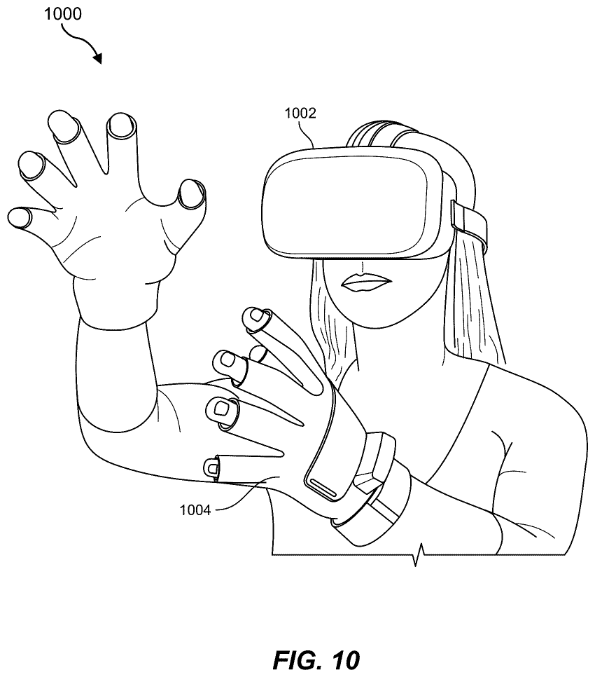

Haptic wearables, such as those shown in and described in connection with FIG. 9, may be implemented in a variety of types of artificial-reality systems and environments. FIG. 10 shows an example artificial-reality environment 1000 including one head-mounted virtual-reality display and two haptic devices (i.e., gloves), and in other embodiments any number and/or combination of these components and other components may be included in an artificial-reality system. For example, in some embodiments there may be multiple head-mounted displays each having an associated haptic device, with each head-mounted display and each haptic device communicating with the same console, portable computing device, or other computing system.

Head-mounted display 1002 generally represents any type or form of virtual-reality system, such as virtual-reality system 800 in FIG. 8. Haptic device 1004 generally represents any type or form of wearable device, worn by a user of an artificial-reality system, that provides haptic feedback to the user to give the user the perception that he or she is physically engaging with a virtual object. In some embodiments, haptic device 1004 may provide haptic feedback by applying vibration, motion, and/or force to the user. For example, haptic device 1004 may limit or augment a user's movement. To give a specific example, haptic device 1004 may limit a user's hand from moving forward so that the user has the perception that his or her hand has come in physical contact with a virtual wall. In this specific example, one or more actuators within the haptic device may achieve the physical-movement restriction by pumping fluid into an inflatable bladder of the haptic device. In some examples, a user may also use haptic device 1004 to send action requests to a console. Examples of action requests include, without limitation, requests to start an application and/or end the application and/or requests to perform a particular action within the application.

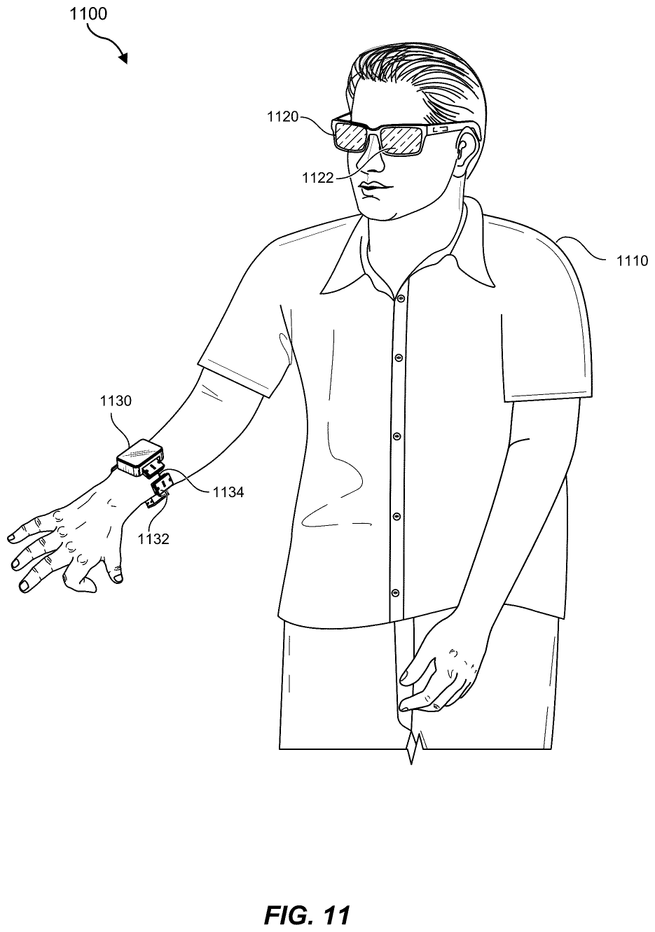

While haptic interfaces may be used with virtual-reality systems, as shown in FIG. 10, haptic interfaces may also be used with augmented-reality systems, as shown in FIG. 11. FIG. 11 is a perspective view of a user 1110 interacting with an augmented-reality system 1100. In this example, user 1110 may wear a pair of augmented-reality glasses 1120 that may have one or more displays 1122 and that are paired with a haptic device 1130. In this example, haptic device 1130 may be a wristband that includes a plurality of band elements 1132 and a tensioning mechanism 1134 that connects band elements 1132 to one another.

One or more of band elements 1132 may include any type or form of actuator suitable for providing haptic feedback. For example, one or more of band elements 1132 may be configured to provide one or more of various types of cutaneous feedback, including vibration, force, traction, texture, and/or temperature. To provide such feedback, band elements 1132 may include one or more of various types of actuators. In one example, each of band elements 1132 may include a vibrotactor (e.g., a vibrotactile actuator) configured to vibrate in unison or independently to provide one or more of various types of haptic sensations to a user. Alternatively, only a single band element or a subset of band elements may include vibrotactors.

Haptic devices 910, 920, 1004, and 1130 may include any suitable number and/or type of haptic transducer, sensor, and/or feedback mechanism. For example, haptic devices 910, 920, 1004, and 1130 may include one or more mechanical transducers, piezoelectric transducers, and/or fluidic transducers. Haptic devices 910, 920, 1004, and 1130 may also include various combinations of different types and forms of transducers that work together or independently to enhance a user's artificial-reality experience. In one example, each of band elements 1132 of haptic device 1130 may include a vibrotactor (e.g., a vibrotactile actuator) configured to vibrate in unison or independently to provide one or more of various types of haptic sensations to a user.

The process parameters and sequence of the steps described and/or illustrated herein are given by way of example only and may be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A head-mounted display comprising:
an electronic display configured to emit light; and
a pancake lens optically coupled to the electronic display, the pancake lens comprising a beam splitter configured to:
transmit a spatial average fraction of the light; and
reflect an additional spatial average fraction of the light that is less than the spatial average fraction of the light.

2. The head-mounted display of claim 1, wherein the spatial average fraction of the light is at least 60 percent of the light.

3. The head-mounted display of claim 1, wherein:
the beam splitter comprises a center region and a perimeter region; and
the beam splitter exhibits a gradation of transmissibility from the center region to the perimeter region.

4. The head-mounted display of claim 3, wherein the gradation of transmissibility comprises transmissibility in the center region that is at least 5 percent higher than transmissibility in the perimeter region.

5. The head-mounted display of claim 1, wherein:
the light emitted by the electronic display is linearly polarized; and
the pancake lens comprises:
a quarter wave retarder that converts the linearly polarized light to circularly polarized light; and
a reflective polarizer system configured to reflect the circularly polarized light.

6. The head-mounted display of claim 5, wherein the reflective polarizer system comprises:
an additional quarter wave retarder that converts the circularly polarized light to linearly polarized light; and
a reflective polarizer that reflects the linearly polarized light.

7. The head-mounted display of claim 6, wherein the reflective polarizer comprises at least one of:
a multilayered birefringent polymer reflective polarizer;
a cholesteric reflective polarizer; or
a wire grid.

8. The head-mounted display of claim 6, wherein:
the beam splitter is positioned between the electronic display and the quarter wave retarder; and
the reflective polarizer is positioned between the quarter wave retarder and the additional quarter wave retarder.

9. The head-mounted display of claim 6, wherein:
the quarter wave retarder is positioned between the electronic display and the beam splitter; and
the additional quarter wave retarder is positioned between the beam splitter and the reflective polarizer.

10. The head-mounted display of claim 1, wherein the beam splitter comprises a thin optical coating disposed on a lens.

11. The head-mounted display of claim 10, wherein the thin optical coating comprises at least one of:
an aluminum coating;
a silver coating;
a gold coating; or
a copper coating.

12. The head-mounted display of claim 10, wherein the thin optical coating comprises at least one dielectric layer.

13. The head-mounted display of claim 10, wherein the thin optical coating comprises one or more layers of metal and dielectric material.

14. The head-mounted display of claim 1, wherein the spatial average fraction of the light comprises an average of values measured over a certain region of the beam splitter.

15. An artificial-reality system comprising:
an electronic display;
at least one processing device communicatively coupled to the electronic display and configured to direct the electronic display to emit light; and
a pancake lens optically coupled to the electronic display, the pancake lens comprising a beam splitter configured to:
transmit a spatial average fraction of the light; and
reflect an additional spatial average fraction of the light that is less than the spatial average fraction of the light.

16. The artificial-reality system of claim 15, wherein the spatial average fraction of the light is at least 60 percent of the light.

17. The artificial-reality system of claim 15, wherein:
the beam splitter comprises a center region and a perimeter region; and
the beam splitter exhibits a gradation of transmissibility from the center region to the perimeter region.

18. The artificial-reality system of claim 17, wherein the gradation of transmissibility comprises transmissibility in the center region that is at least 5 percent higher than transmissibility in the perimeter region.

19. The artificial-reality system of claim 17, wherein:
the light emitted by the electronic display is linearly polarized; and
the pancake lens comprises:
a quarter wave retarder that converts the linearly polarized light to circularly polarized light; and
a reflective polarizer system configured to reflect the circularly polarized light.

20. A method comprising:
installing an electronic display into a head-mounted system;
assembling a pancake lens that comprises a beam splitter; and
optically coupling the pancake lens to the electronic display in the head-mounted system such that the beam splitter is configured to:
transmit a spatial average fraction of light emitted by the electronic display; and
reflect an additional spatial average fraction of the light that is less than the spatial average fraction of the light.
